(19) United States
(12) Patent Application Publication
(10) Pub. No.: US 2003/0222420 A1
(43) Pub. Date: Dec. 4, 2003

(54) Composit sport board

(76) Inventors: David Herbert Hadzicki, San Diego, CA (US); Joseph Robert Hadzicki, Coronado, CA (US); Michael Tracy Lopez, La Mesa, CA (US)

Correspondence Address: LEONARD TACHNER, A PROFESSIONAL LAW CORPORATION, SUITE 38-E, 17961 SKY PARK CIRCLE, IRVINE, CA, 92614-6364, US

(21) Appl. No.: 10/160,734

(22) Filed: Jun. 1, 2002

(51) Int. Cl. B62M 1/00

(52) U.S. Cl. 280/87.042

(57) ABSTRACT

An elongated composite board having a top surface, bottom surface, front, back, left and right sides. Tubular sections are sandwiched between the top and bottom surfaces, with multiple pocket areas throughout the board directly connecting the top surface to the bottom surface, and multiple foam filled sections which can be oriented longitudinally, laterally and diagonally throughout the board.

### BACKGROUND OF THE INVENTION

1. Field of the Invention

The present invention relates generally to sports board structures such as for skate boards, wake boards, snow boards, surf boards and kite boards. The invention relates more specifically to a fiber reinforced sports board consisting of a top surface, bottom surface, front, back, left and right sides wherein tubular sections are sandwiched between the top and bottom surfaces, with multiple pocket areas throughout the board directly connecting the top surface to the bottom surface.

2.Background Art

Earlier sport board designs employ various materials, shapes and designs. These have had varying success. For example, plastic skate boards, although they are not high performance boards, are inexpensive and acceptable for small children not demanding high performance. On the other hand, aluminum skate boards with higher performance characteristics, have other disadvantages such as metal edges that sharpen with use, and unacceptable noise characteristics. Moreover, they tend to bend and permanently deform with use. The most widely accepted current skate board is the laminated wood design. The most common short-comings of the wood design are gradual loss of flex stiffness causing degraded performance over time, lack of overall stiffness, excessive weight, low durability, inconsistent characteristics from board to board, uncontrolled variation in stiffness from board to board due in part to variations in wood to wood glue interaction and moisture effects.

### SUMMARY OF THE INVENTION

The present invention addresses all of the disadvantages of the wood board design. The new composite board design disclosed herein is not only stiffer, but its stiffness is completely controllable. The flex performance is significantly higher to start with and does not degrade over time. The weight is approximately 20-30% lighter. The board, under general use, is at least twice as durable. Due to the precisely controlled materials and construction techniques, consistency is very high from board to board.

In the preferred embodiment the sports board includes an elongated composite board having a top surface, bottom surface, front, back, left and right sides. Tubular sections are sandwiched between the top and bottom surfaces, with multiple pocket areas throughout the board directly connecting the top surface to the bottom surface, and multiple foam filled sections which can be oriented longitudinally, laterally and diagonally throughout the board.

By utilizing two or more fiber angles, the stiffness, weight and durability of the board are controlled by four variables: material density, material stiffness, fiber orientation and geometric shape.

Stiffness and durability requirements vary throughout different areas of the board. For example, grinding areas need to be tougher and denser, while the span between the wheel trucks needs to be stiffer. By optimizing the use of these four variables and their location throughout the board, the weight can be decreased while the durability and stiffness are increased.

Unidirectional, high modulus fibers on longitudinal tubular sections, increase longitudinal stiffness while decreasing the weight. By filling areas with foam, the geometric stiffness is increased while the density is much less than wood. By pinching the upper and lower surfaces together at different points to form pockets throughout the board, shearing movement between the upper and lower surfaces is eliminated. The fiber angle is varied from 0 degrees, to 30 degrees, to 45 degrees, to 90 degrees to enhance the torsional stiffness while fracture resistance is increased along the primary longitudinal and lateral axes.

A combination of materials is used throughout the board to decrease weight, increase stiffness and increase durability. To increase stiffness, a high modulus fiber reinforced plastic (FRP) is used. The properties of this material include: High stiffness, high strength, and low density. Some examples of materials that meet these requirements include carbon fiber, Kevlar™, Spectra™ and fiberglass. A low density filler material is used to decrease the overall density of the board. Some examples of materials that meet this requirement include foam, foam plastic, low density wood, wood composite, honeycomb, layered plastic and an inflatable bladder. An abrasion resistant material is used in high impact locations on the board and high abrasion areas. Some examples of this material include ABS, polyethylene and nylon.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a component lay up view of a typical skate board embodiment of the invention;

FIG. 2 is a cross-sectional view of a first embodiment;

FIG. 3 is a cross-sectional view of a second embodiment;

FIG. 4 is a cross-sectional view of a third embodiment;

FIG. 5 is a cross-sectional view of a fourth embodiment;

FIG. 6 is a cross-sectional view of a fifth embodiment;

FIG. 7 is a cross-sectional view of a sixth embodiment;

FIG. 8 is a cross-sectional view of a seventh embodiment;

FIG. 9 is a cross-sectional view of a eighth embodiment;

FIG. 10 is a partial component lay up view of another skate board embodiment of the invention ; and

FIG. 11 is a cross-sectional view taken along lines 11-11 of FIG. 10.

### DETAILED DESCRIPTION OF A PREFERRED EMBODIMENT

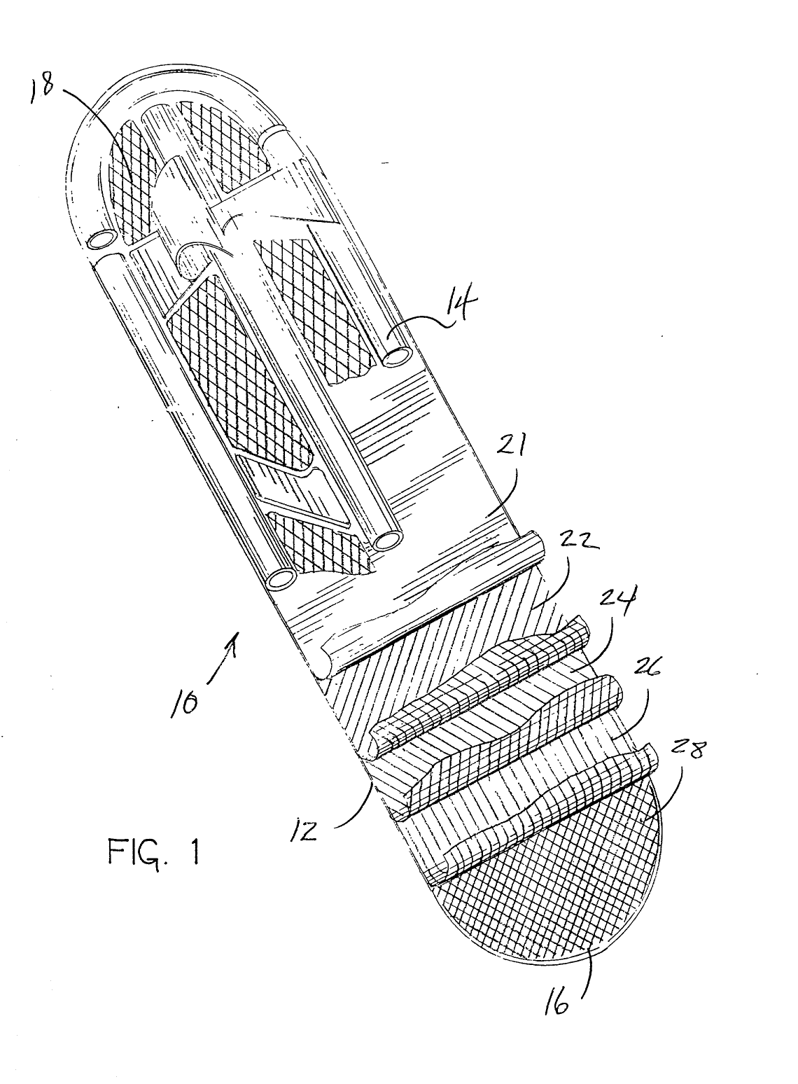

Referring first to FIG. 1, it will be seen that a skate board deck 10 comprises top and bottom elongated major surfaces 12, each formed with a plurality of laminated, cured, resin impregnated, fiber layers. Such fiber layers may be made of carbon, Kevlar™, Spectra™, or fiberglass, or various combinations thereof. The multiple layers of fiber are varied in an angular direction relative to the long axis of the deck to increase longitudinal, lateral and torsional stiffness and fracture resistance. By way of example, layer 21 is at 90 degrees to the board axis, layer 22 is at about +45 degrees, layer 24 at −45 degrees, layer 26 at 0 degrees and layer 28 has fibers at +45 and −45 degrees.

A significant structural feature of the invention is a plurality of tubular members 14 positioned at various selected locations between the top and bottom surfaces 12. The tubular members are preferably made of high modulus fibers. The longitudinal orientation of these tubular members 14 greatly increases the longitudinal stiffness of the deck 10. By varying the ply angles within the tube, the torsional stiffness and hoop strength can be modified. Moreover, by providing tubular members 14 along the edges of the deck including the edges along edge surface 16, the durability of the deck is also enhanced. Tubular members 14 also act as spacers between the top and bottom surfaces. The regions between the surfaces are configured in various ways. In one such configuration, the spacing between the top and bottom surfaces is maintained and is filled with a cured foam or foam-like material to reduce overall density of the deck while increasing stiffness. In another such configuration, the top and bottom surfaces are pinched together to preclude shearing movement between the top and bottom surfaces. At each such location of pinching, it is the bottom surface which is preferably pinched toward the top surface to form a pocket 18 in the bottom exterior of the deck. Some or all of those pockets may be optionally filled with foam or foam-like material 20 and covered by a layer of fiber to prevent such pockets from interfering with performance.

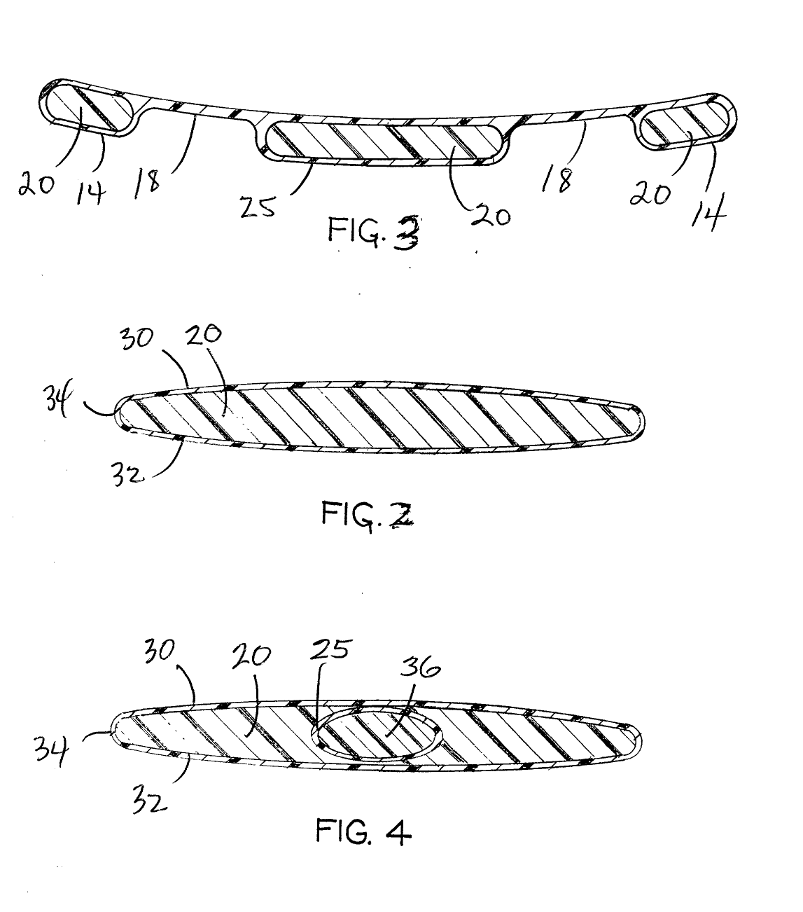

Some of the various alternative interior configurations are illustrated in cross-sectional FIGS. 2 through 9. FIG. 2 provides a view of a simple configuration of a deck comprising upper major surface 30, lower major surface 32 and edge surface 34 forming an interior filled with a foam 20. FIG. 3 shows a more complex configuration suitable for that portion of the deck adjacent the truck wheels (not shown). In this embodiment, the deck comprises edge tubes 14, central tube 25 and a pair of pockets 18. The tubes 14 and 25 are filled with low density foam 20.

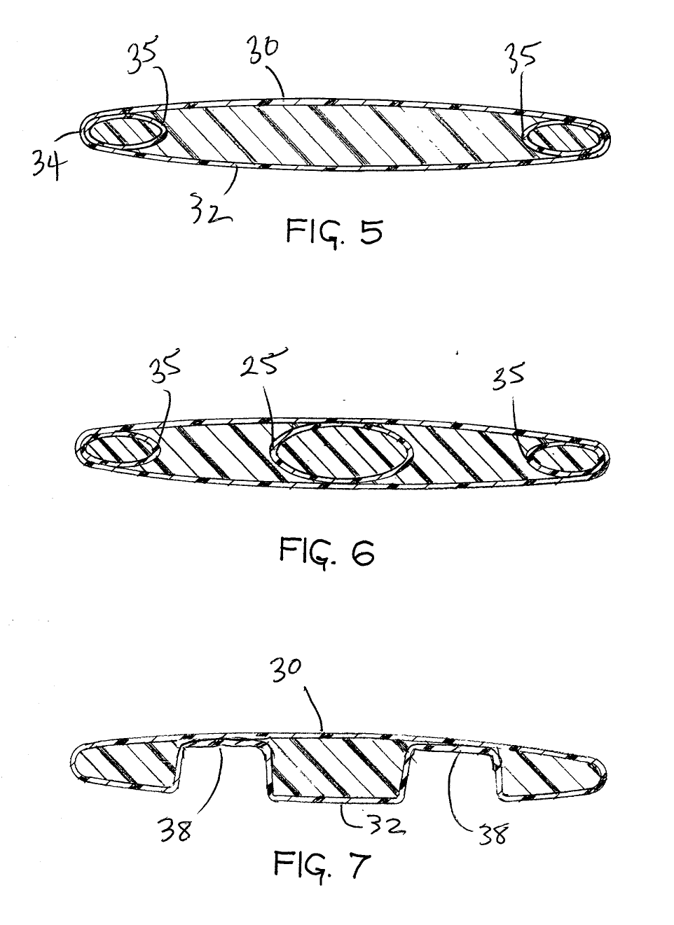

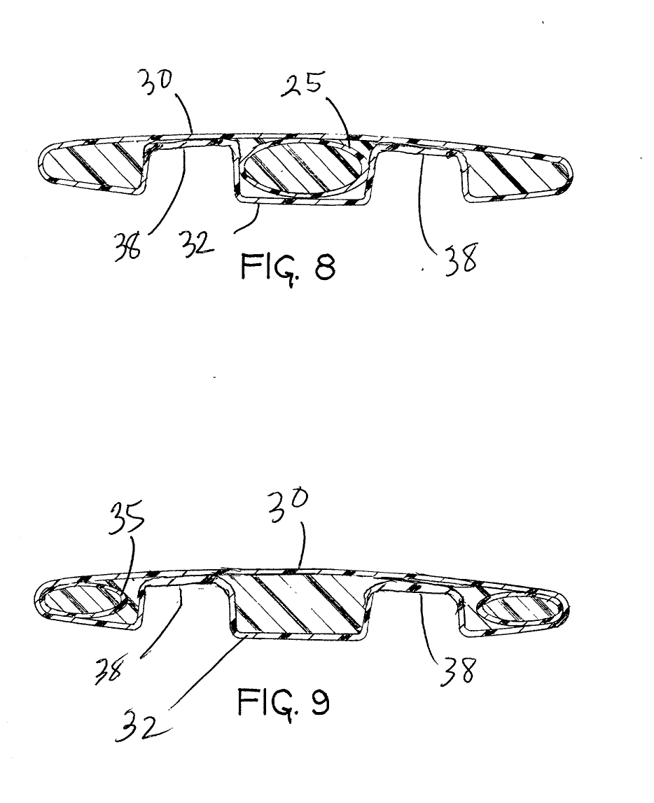

In FIG. 4, a central tube 25, filled with foam 36 is added to the configuration of FIG. 2. In FIG. 5, edge tubes 35 are added to the configuration of FIG. 2 and in FIG. 6, both edge tubes 35 and central tube 25 are added to the configuration of FIG. 2. The configuration of FIG. 2 is shown modified differently in the embodiment of FIG. 7 wherein a pair of pockets 38 are formed by pinching the lower major surface 32 toward the upper major surface 30 before the FRP is cured. In FIG. 8 and FIG. 9, pockets 38 are shown combined with central tube 25 and edge tubes 35, respectively.

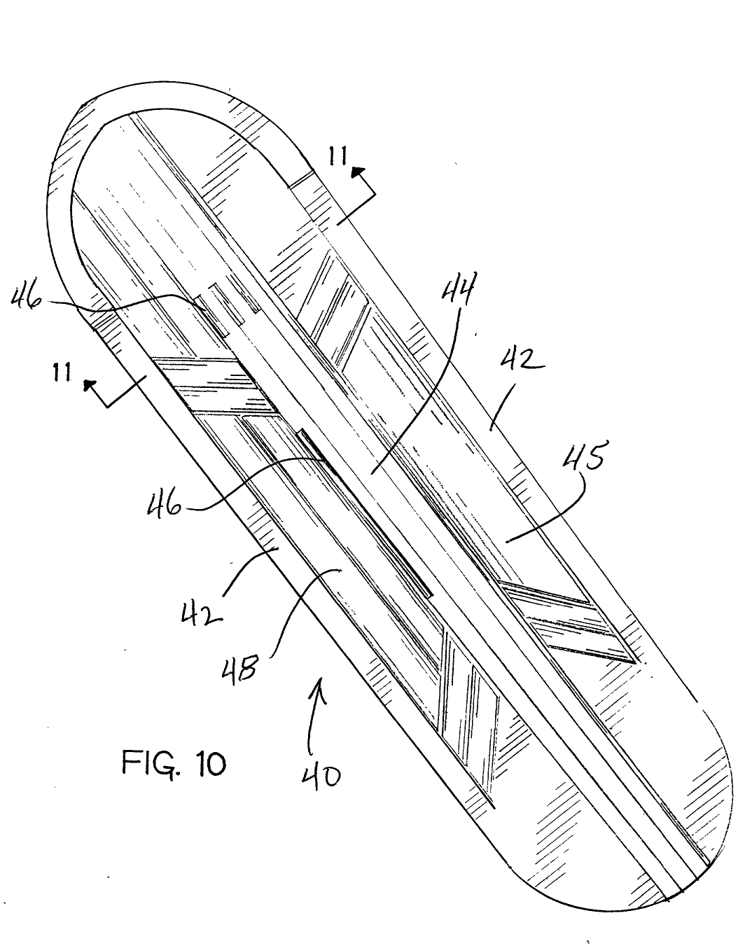

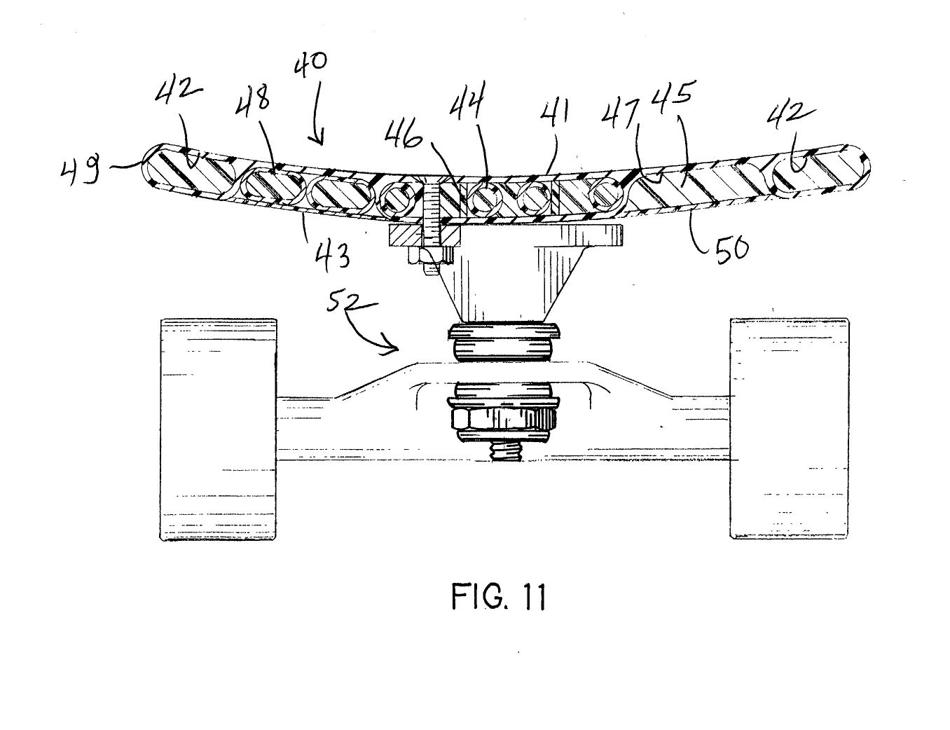

FIGS. 10 and 11 illustrate a skate board deck in accordance with the invention wherein various weight and stiffness-control features are employed. A deck 40 has upper major surface 41, lower major surface 43 and edge surface 49 forming an interior having edge tubes 42 and a plurality of parallel central tubes 44. A pocket 47 is covered by a layer 50 of FRP and filled with foam 45, as are the tubes. Discrete vertical fiber reinforcements 46 provide added strength which is especially useful adjacent the attached truck wheel assembly 52.

Thus it will be understood that the invention comprises a unique sport board which utilizes a variety of weight, strength and stiffness control features in an FRP-based material. Elongated stiffness tubes, selected use of fiber versus foam and pockets help define stiffness, strength, weight and durability to optimize performance. It will be understood that while skate board configurations are shown herein, the unique features of the invention are readily applicable to other types of sport boards wherein it would be advantageous to control weight, stiffness, strength and durability.

We claim:

1. A skate board deck comprising:
a pair of substantially parallel surfaces spaced from each other to form an interior region, each such surface being formed of a plurality of cured, resin impregnated, composite fiber layers, each such layer having a selected orientation;
at least one tubular member positioned between said surfaces in said interior region for stiffening said deck; and
a low density filler material substantially filling the remainder of said interior region.

2. The skate board deck recited in claim 1 wherein said parallel surfaces are pinched together at at least one location along said deck to resist shearing movement between said surfaces.

3. The skate board deck recited in claim 2 wherein a pocket is formed in at least one of said surfaces at said pinching location.

4. The skate board deck recited in claim 3 wherein said pocket is filled with a low density filler material.

5. The skate board deck recited in claim 4 wherein said filler material in said pocket is covered by at least one layer of composite fiber material.

6. The skate board deck recited in claim 1 wherein said substantially parallel surfaces are made from material taken from the group consisting of carbon fiber, Kevlar™, Spectra™ and fiberglass.

7. The skate board deck recited in claim 1 wherein said low density filler material is taken from the group consisting of foam, foam plastic, low density wood, wood composite, honeycomb structured materials, layered plastic materials and air-filled bladder configured materials.

8. The skate board deck recited in claim 1 further comprising an abrasion-resistant material applied to said deck at selected locations.

9. The skate board deck recited in claim 8 wherein said abrasion-resistant material is taken from the group consisting of acrylonitrile-butadiene-styrene copolymer, polyethylene and nylon.

10. A sports board comprising:
fiber reinforced plastic material surfaces forming an interior region, said region being substantially filled with a low density core material.

11. The sports board recited in claim 10 further comprising at least one centrally located tubular spine positioned within said interior region.

12. The sports board recited in claim 11 wherein said at least one spine is made of a material that is the same material used in said surfaces.

13. The sports board recited in claim 10 further comprising at least one elongated tubular edge member located within said interior region along the edges of said surfaces.

14. The sports board recited in claim 13 wherein said at least one edge member is made of the same material as said surfaces.

15. The sports board recited in claim 10 wherein said surfaces are pinched together at at least one location on said board to form a shearing movement-resistant pocket.

16. The sports board recited in claim 15 wherein said pocket is filled with a low density material and covered by a layer of fiber.

17. The sports board recited in claim 10 wherein said surfaces are formed from multiple layers of fiber, said layers being oriented in at least two distinct directions.

18. The sports board recited in claim 10 wherein said surfaces are formed from multiple layers of fiber, said layers having selected distinct thicknesses at various locations on said deck.

19. A method of fabricating an elongated sport board to achieve desired weight and stiffness, the method comprising the steps of:
forming said board with upper and lower major surfaces and a substantially continuous edge surface, said major surfaces and edge surface providing an interior, said major and edge surfaces being made of a curable, resin-based fiber material;
adding a curable foam to said interior;
creating tubular stiffening members of selected lengths; and
placing said tubular stiffening members in said interior.

20. The method recited in claim 19 further comprising the step of orienting said resin-based fiber material in selected alternative directions.

21. The method recited in claim 19 wherein said resin-based fiber material is a fiber reinforced plastic.

22. The method recited in claim 19 further comprising the step of providing pockets at selected locations along said major surfaces, said pockets being formed by pinching said upper and lower major surfaces together and adhering them to one another within said interior.
